(19) United States
(12) Patent Application Publication
(10) Pub. No.: US 2015/0154655 A1
(43) Pub. Date: Jun. 4, 2015

(54) SYSTEMS AND METHODS OF PROVIDING PARKED DOMAIN CONTENT

(71) Applicants: William David Reardon, Monica, CA (US); Kai Chen, Santa Monica, CA (US)

(72) Inventors: William David Reardon, Monica, CA (US); Kai Chen, Santa Monica, CA (US)

(21) Appl. No.: 13/631,472

(22) Filed: Sep. 28, 2012

(51) Int. Cl. G06Q 30/02; G06Q 30/08

(52) U.S. Cl. CPC G06Q 30/0275

(57) ABSTRACT

Systems and methods of providing content on a computer network are provided. A parked domain of the computer network is identified. The parked domain corresponds to an internet domain name associated with a web page. A data processing system can assign an assigned value to the web page. The assigned value can include an indication of revenue generated by a plurality of content items configured for display on the web page. A bid from a content provider to provide exclusive content for display on the web page can be received at the data processing system, and the data processing system can determine a bid value corresponding to the bid. The bid value can be compared with the assigned value to identify the bid as a winning bid, and the content placement circuit can provide the exclusive content corresponding to the winning bid for display on the web page.

### BACKGROUND

In a networked environment such as the Internet, entities such as people or companies provide information for public display on web pages. The web pages can include text, video, or audio information provided by the entities via a web page server for display on the Internet. Additional content such as advertisements can also be provided by third parties for display on the web pages together with the information provided by the entities. Thus, a person viewing a web page can access the information that is the subject of the web page, as well as third party advertisements that may or may not be related to the subject matter of the web page.

### SUMMARY

At least one aspect is directed to a computer implemented method of providing content on a computer network. The method identifies a parked domain of the computer network. The parked domain corresponds to an internet domain name associated with a web page. The method assigns, by a data processing system, an assigned value to the web page. The assigned value includes an indication of revenue generated by a plurality of content items configured for display on the web page. The method receives, at the data processing system, a bid from a content provider to provide exclusive content for display on the web page, and determines a bid value corresponding to the bid. The method compares the bid value with the assigned value to identify the bid as a winning bid, and can provide the exclusive content corresponding to the winning bid for display on the web page.

At least one aspect is directed to a system of providing content via a computer network. The system includes one or more data processors; and one or more storage devices storing instructions that when executed by the one or more data processors, cause the one or more data processors to perform operations including identifying a parked domain of the computer network. The parked domain corresponds to an internet domain name associated with a web page. The operations can include assigning an assigned value to the web page. The assigned value includes an indication of revenue generated by a plurality of content items configured for concurrent display on the web page. The operations can include receiving via the computer network, a bid from a content provider to provide exclusive content for display on the web page, and identifying a bid value corresponding to the bid. The operations can include comparing the bid value with the assigned value to identify the bid as a winning bid, and providing the exclusive content corresponding to the winning bid for display on the web page.

At least one aspect is directed to a computer readable storage device storing instructions that when executed by one or more data processors, cause the one or more data processors to perform operations including identifying a parked domain of a computer network. The parked domain corresponds to an internet domain name associated with a web page. The operations include assigning an assigned value to the web page that includes an indication of revenue generated by a plurality of content items configured for concurrent display on the web page. The operations include receiving a bid to provide exclusive content for display on the web page, and determining a bid value corresponding to the bid. The operations include comparing the bid value with the assigned value to identify the bid as a winning bid, and providing the exclusive content corresponding to the winning bid for display on the web page.

These and other aspects and embodiments are discussed in detail below. The foregoing information and the following detailed description include illustrative examples of various aspects and embodiments, and provide an overview or framework for understanding the nature and character of the claimed aspects and embodiments. The drawings provide illustration and a further understanding of the various aspects and embodiments, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram of an example environment to provide content on a computer network, according to an illustrative implementation;

FIG. 2 is a flow diagram depicting a method of providing content on a computer network, according to an illustrative implementation; and

FIG. 3 is a block diagram illustrating a general architecture for a computer system that may be employed to implement various elements of the systems and methods described and illustrated herein, according to an illustrative implementation.

### DETAILED DESCRIPTION

Following below are more detailed descriptions of various concepts related to, and embodiments of, methods, apparatuses, and systems of providing content on a computer network. The various concepts introduced above and discussed in greater detail below may be implemented in any of numerous ways, as the described concepts are not limited to any particular manner of implementation. Examples of specific implementations and applications are provided primarily for illustrative purposes.

One implementation is directed toward providing advertising on web pages associated with a parked domain. Parked domain web pages may display advertisements but do not otherwise provide any substantive content, e.g., from the domain name owner. Parked domain web pages may be referred to as empty web pages.

Advertisers or other content providers can provide content items such as advertisements that are displayed on the parked domain web page when that web page is rendered to a user. An auction can be held, where a data processing system determines which content items to provide to web pages. The advertisers can submit monetary bids to have their content items placed on a web page, and the advertiser having the highest bid may have their content item displayed to a user on the web page. Multiple content items such as advertisements can share space on the web page and be the only substantive content available on the otherwise empty web page associated with the parked domain.

The systems and methods described herein can receive a bid from a content provider to exclusively display a content item (e.g., without displaying any other content item) on the parked domain web page. The value of the received bid can be compared with an assigned value of revenue generated from providing multiple content items to the same web page. In one example where content items are advertisements, the data processing system selects the greater of the bid value (for the exclusive parked domain web page advertisement) and the assigned value (for one or more other non-exclusive advertisements), and provides the advertisement(s) corresponding to the selected bid value to the parked domain web page for display to a user. The non-exclusive advertisements may be generic advertisements provided to multiple web pages for display. The exclusive parked domain web page advertisement in this example can be customized for a web page of a parked domain. For example, the exclusive advertisement can be a full page advertisement associated with content indicated by the domain name of the parked domain as described further herein.

Thus, exclusive content such as a full page advertisement or other content item can be selected for display on web pages of parked domains. The systems and methods described herein can determine whether or not the bid value offered to display the exclusive content on the parked domain increases revenue to the provider of an ad placement auction or to a web page operator respective to assigned revenue that can be generated by placing non-exclusive content from one or more advertisers on the same web page. If revenue is enhanced, the exclusive content can be provided to the parked domain web page for display. In one implementation, the full page auctioning of dedicated content for web pages of parked domains increases monetization of the parked domain web pages.

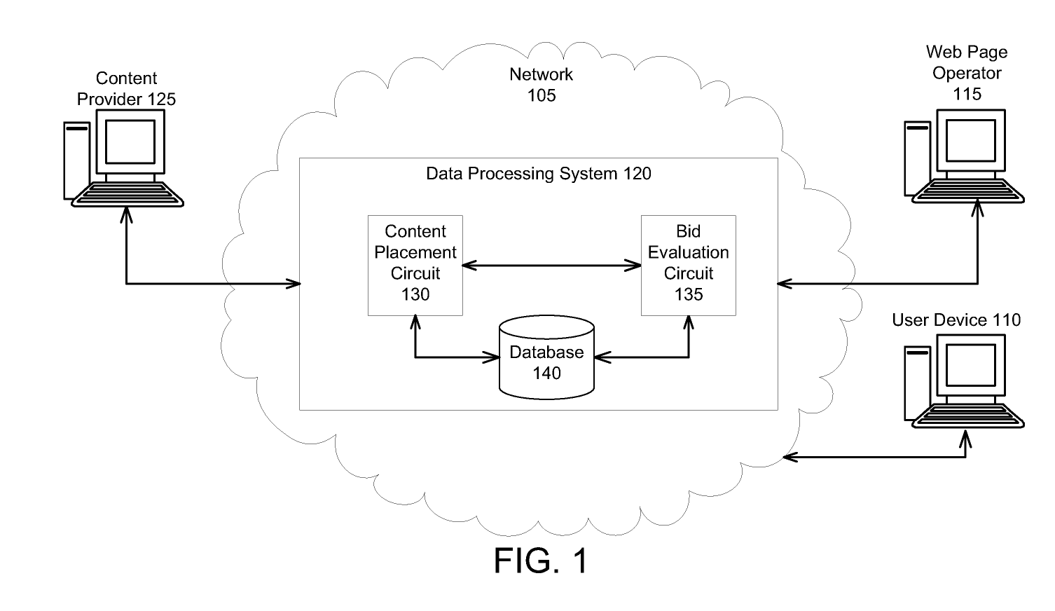

FIG. 1 illustrates an example system 100 of providing content via a computer network such as network 105 according to an implementation of the present disclosure. The network 105 can include computer networks such as the Internet, local, metro, or wide area networks, intranets, and other communication networks such as mobile telephone networks. The network 105 can be used to access web pages that can be displayed on at least one user device 110, such as a lap top, desk top, tablet, personal digital assistants, smart phones, or portable computers. For example, via the network 105 a user of user device 110 can access web pages provided by the web page operator 115. In this example, a web browser of the user device 110 can access a web server of the web page operator 115 to retrieve a web page for display on a monitor of the user device 110. The web page operator 115 generally includes an entity that operates a web page as well as the web page server that communicates with the network 105 to make the web page available to the user device 110.

The system 100 can also include at least one data processing system 120. The data processing system 120 can include at least one processor or logic device to communicate via the network 105 with at least one content provider 125 and at least one web page operator 115. The data processing system 120 can also include at least one content placement circuit 130, at least one bid evaluation circuit 135, and at least one database 140. In some implementations, the data processing system 120 includes one or more data processors; and one or more storage devices storing instructions that when executed by the one or more data processors, cause the one or more data processors to perform operations and acts described herein.

In one implementation, the data processing system 120 identifies a parked domain on the computing network 105. For example, the parked domain can be an Internet domain name (or other identification string) that identifies a web page stored in a web server of the web page operator 115. In this example, the parked domain has an Internet domain name corresponding to a web page that is devoid of content, e.g., the web site is empty or is not used to provide any information from the web page operator 115 to a user of the user device 110. In one implementation, the data processing system 120 receives information from a web crawler, bot, or other computer program and evaluates this information to identify a parked domain. In some implementations, the data processing system 120 receives information from the content provider 125 or the web page operator 115 that identifies a parked domain.

The content provider 125 may provide content for display on a web page associated with a parked domain. For example, the content placement circuit 130 can provide content items such as advertisements from one or more content providers 125 for display on the parked domain web page. The advertisements can advertise goods or services of the content provider 125. In one implementation, the data processing system 120 determines an assign value of the web page. For example, the data processing system 120 can determine revenue that may be obtained from the display of advertisements on the web page of the parked domain (or any other web page including those not associated with a parked domain). In this example, the advertisements can be the only substantive content displayed on the web page. In one implementation, the assigned value of the web page is an estimated value.

The assigned value determined by the data processing system 120 can include the indication of revenue generated by multiple advertisements that are concurrently or sequentially displayed on the web page of the parked domain. For example, a web page of a parked domain may have a display that consists of a number of displayed advertisements and no further substantive data, e.g., no information regarding any product or service of the web page operator. The advertisements may be displayed at different portions of the web page, such as the top, sides, bottom, banner, above the fold, or below the fold. In this example, the data processing system 120 can determine the total revenue generated by these advertisements to determine a total value of the web page. The revenue determination can be associated with a defined time period.

In one implementation, the data processing system 120 determines an estimated cost per impression (ECPI) to determine the total revenue potential of the parked domain web page. For example, the data processing system 120 can determine a number of impressions of the web site, e.g., a number of times the web page has been visited. From this information, the data processing system 120 can determine the total revenue generated from the display of a plurality of advertisements on the parked domain web page. In one implementation, the data processing system 120 determines a total revenue during a defined time period (such as one day or a 24 hour time period) for ads provided for display on a web page, and divides this number by the total number of impressions of the web page during that time period to determine an actual cost per impression value for that time period. This actual cost per impression value can be determined over multiple consecutive days or weeks, or other time periods. The data processing system 120 can average the actual cost per impression values to determine the estimated cost per impression.

The estimated cost per impressions can be based on various numbers of impressions, such as an estimated cost per thousand, million, or other number of impressions. Other metrics, such as an estimated total cost, estimated cost per click or per sale or other cost per action metric may be used to assign a value to a web page of a parked domain for advertising placement purposes. In one implementation, the assigned value indicates what advertisers may pay to have multiple advertisements displayed on a web page.

Via the network 105 a user of the user device 110 may request access to a web server of the web page operator 115 to render the web page associated with the parked domain. The data processing system 120 can receive notification of this request for access, and implement an auction to provide ads or other content items to that rendering of the web page. For example, the data processing system 120 can provide multiple ads from various sources for concurrent display, or can provide one ad customized for a particular parked domain or for generic parked domains in general, and can provide the customized ad for exclusive display.

In one implementation, the data processing system 120 receives a bid from the content provider 125 to provide content for display on the parked domain web page. The bid evaluation circuit 135 can compare the bid with the total revenue determined using the estimated cost per impression (or other metric). The bid evaluation circuit 135 can determine that this bid is greater than the value assigned to the web page. For example, the data processing system 120 can determine that the ECPI is $0.50 for a parked domain web page by averaging actual cost per impression values over a previous number of days. A bid of, for example $0.60 to provide exclusive content to a parked domain is, in this example, identified as a winning bid that will generate more revenue (e.g., $0.60 per impression) than the assigned value associated with an alternative, (e.g., $0.50 per impression) currently generated by providing multiple advertisements from one or more other advertisers.

In one implementation, the content placement circuit 130 can provide content corresponding to the winning bid for display on the web page to the user of the user device 110. For example, the content placement circuit 130 can provide an advertisement from the database 140 to the web server of the web page operator 115, or can allow the web server to access the advertisement from the database 140 or from another source, such as a database associated with the content provider 125 to display the advertisement on the web page associated with the parked domain.

In some implementations, the bid from the content provider 125 is a bid to provide content to the web page. For example, the content provider 125 can provide exclusive content for display on that web page, for example, in the form of a full page ad. In this example, the data processing system 120 can determine advertising revenue (e.g., a value of the web page) when multiple advertisements from the same or different advertisers are provided to the web page and can compare this assigned value with the bid value received from the content provider 125 for the exclusive full page ad during an auction to determine what content to provide to the web page. When, for example, the data processing system 120 determines that the bid for the full page ad generates more revenue than the assigned revenue for providing multiple non-exclusive advertisements to the web page, the content placement circuit 130 can provide the full page ad to the web page operator 115 for display on the web page associated with the parked domain. The revenue for content placement may be provided to an entity that operates the data processing system 120, to the web page operator, or split between these two entities. In one implementation, the full page ad is customized by the content provider 125 for display on the web page of the parked domain. For example, the full page ad can occupy substantially all (e.g., at least 80%) of the web page, leaving little or no room on the web page for any other content.

In one implementation, a web page offering a product e.g., widget.com may be associated with a company and offer a product for sale, widgets in this example. A parked domain in this example can be a misspelling of widget.com, such as wigdet.com, and the web page wigdet.com is an empty web page that exists but does not offer widgets or any other products for sale. Rather, the Internet domain name wigdet.com is a parked domain associated with a web page that is devoid of content in this example. A user of the user device 110 may access wigdet.com via the network 105, for example by inadvertently misspelling widget.com.

Since, in this example the parked domain web page wigdet.com receives some traffic, in one implementation advertisers (such as the content provider 125) may wish to provide ads or other content for display on wigdet.com. A plurality of advertisements can be displayed concurrently on the web page, for example at different portions of the web page, e.g., the top, bottom, or sides of the web page. The data processing system 120 can determine the value of this web page. This determination can include the revenue received from the advertisers to have their content displayed on the web page. The determination may include an estimated cost per impression metric. In one example, the determination can be stored in the database 140. In one implementation, advertising content need not be present on the web page for the data processing system 120 to determine the value of the web page associated with the parked domain, as the determination can indicate the value of the web page if advertisers decide to use the web page to display their content during a defined future time period, e.g., during the next four months.

The content provider 125 can create or obtain content for display on the web page of the parked domain, e.g., wigdet.com. For example, the content provider 125 may produce widgets, or may be the operator of the non-parked domain widget.com. In this example the content provider 125 can create exclusive content for the parked domain web page wigdet.com offering to sell widgets based for example on the determination that some users intend to visit widget.com but accidentally visit wigdet.com due to a typographical error. In this example, the exclusive content can be customized based on the domain name of the parked domain. For example, the ad can offer widgets based on the assumption that some users intend to access a widget.com web page that has content about widgets but instead access a parked domain web page at wigdet.com.

Continuing with this example, the data processing system 120 can receive a bid from the content provider 125 to place the exclusive content on wigdet.com, which may be the web page of the web page operator 115 in this example. The data processing system 120 can compare the bid received from the content provider 125 with the determined value assigned to of the web page. The bid evaluation circuit 135 can determine that the higher value, or the value that results in the most revenue for the operator of the data processing system 120, is the winning bid. When, for example the bid from the content provider 125 is the winning bid, the content placement circuit 130 can communicate with the content provider 125 or the database 140 to provide the exclusive content to the wigdet.com. In another example, when the determined value assigned to the web page exceeds the bid received from the content provider 125, the data processing system 120 can deny the exclusive content of the content provider from display on the web page, and instead provide other advertisements to the web page.

In one implementation, content of the content provider 125 provided to the web page operator 115 for display on the web page associated with the parked domain can redirect the user device 110 from the parked domain web page to another web page. For example, exclusive content of the content provider 125 displayed on wigdet.com may include an advertisement for widgets and after a time period, e.g. less than 15 seconds, the user device 110 can be redirected from the parked domain web page wigdet.com to the non-parked domain widget.com that includes content about widgets. In this example the user is redirected from a parked domain web page to a web page associated with the content provider 125 responsible for the exclusive content (e.g., the advertisement) displayed on the parked domain web page.

The exclusive content of the content provider 125 may be a full page advertisement. The full page advertisement may but need not occupy the entire web page associated with the parked domain. For example, the full page advertisement can occupy less then all of the web page, with remaining portions of the web page being devoid of substantive content, such as other advertisements. In one implementation, the full page advertisement is provided to the web page of the parked domain, and the data processing system 120 excludes other content from the web page, for example by denying bids from providers of that content. In some examples, the exclusive content includes multiple full page advertisements that can be displayed sequentially on the web page.

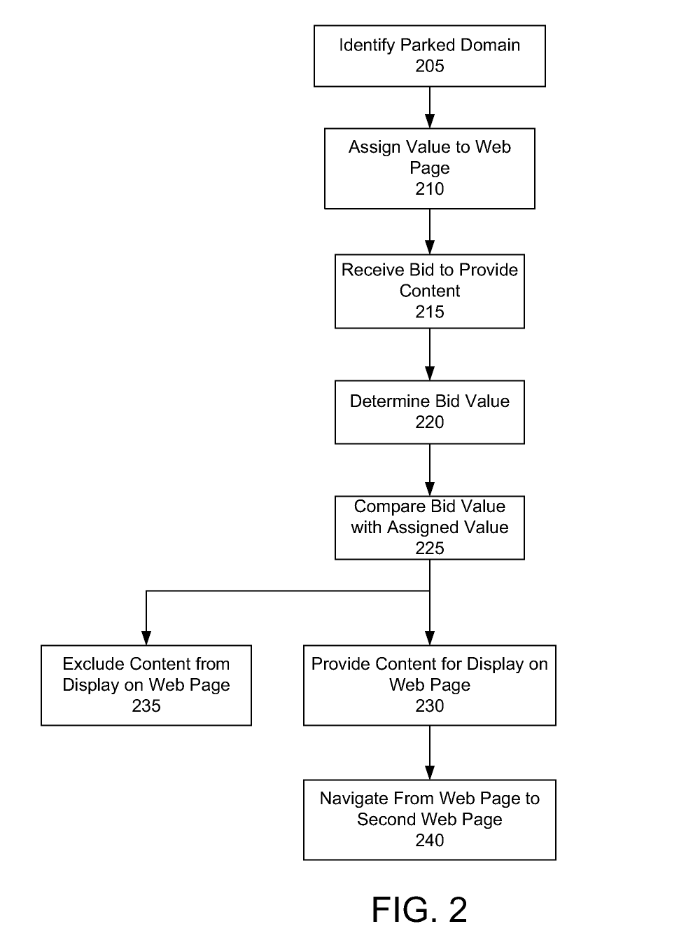

FIG. 2 illustrates a flow diagram depicting a method 200 of providing content on a computer network. The method 200 identifies a parked domain (BLOCK 205). In one implementation the method 200 includes at least one data processing system configured to identify or determine a network domain name that corresponds to a parked domain web page. The blocked domain can be identified from information provided by a web crawler or bot program that accesses the network, or from information received from a content provider or web page operator that indicates the existence of a parked domain.

The method 200 can also assign a determined value to a web page (BLOCK 210), such as a web page of a parked domain or any other web page. In one implementation, the assigned value includes an estimate of revenue generated from a content placement auction that can be run to place content on a web page. For example, the method can determine an estimated cost per impression of a web page (BLOCK 210), which includes an estimate of revenue that can be earned for placing a plurality of advertisements (or other content) on a web page such as a web page of a parked domain. These advertisements can be general advertisements suitable for a plurality of web pages, and not necessarily customized for a parked domain web page. In one implementation, the value assigned to the web page (BLOCK 210) is an estimated value for providing multiple advertisements for concurrent display on a web page, where the multiple advertisements simultaneously occupy different portions (e.g., different ad slots) of the web page.

The method 200 can receive bids to provide content (BLOCK 215) and determine the monetary value (BLOCK 220) of the received bids. In one implementation, the method 200 includes at least one data processing system, for example, having an ad placement server to run an ad placement auction. Monetary bids can be received (BLOCK 215) from content providers to have their content provided for display on a web page during a time period, or during one or more renderings of the web page to a user.

The received bids (BLOCK 215) to provide content to the web page can be for more or less money than the value assigned to the web page (BLOCK 210). In one implementation, the method 200 compares the bid value (BLOCK 220) with the assigned value of the web page (BLOCK 225). For example, the method can determine that a received bid to provide exclusive content to a web page of a parked domain is a winning bid that is greater in value than the assigned value of the web page. In this example, the method 200 provides content corresponding to the winning bid for display on the parked domain web page (BLOCK 230). This may include an advertisement such as a full page ad designed for display on parked domain web pages in general, or on a particular parked domain web page. In this example, the method can exclude other content (e.g., other advertisements) from display on the web page, such as ads that do not correspond to the winning bid (BLOCK 235), and any existing advertisements on the web page can be replaced with the ad corresponding to the winning bid. In one implementation, the content corresponding to the winning bid can include more than one full page advertisement, which can be provided to the web page for sequential display to the user during different time periods.

In another example, the method 200 can compare the received bid value with the value assigned to the web page value (BLOCK 225) and determine that the value assigned to the web page is greater than the received bid value. In this example, the method 200 determines that revenue for the data processing system responsible for placing content for display on web pages and for web page operators can be greater when for example multiple non-full page ads are provided to the web page, and the method 200 can provide this type of content to the web page (BLOCK 230).

In one implementation, the method 200 provides content to the web page that redirects a user device being used to view the web page away from that web page and to a second web page (BLOCK 240). For example, the method 200 can provide an ad that is customized for display on a parked domain web page, such as a full page ad. The advertisement can be provided to run on the web browser of the user device used to access the web page, and can execute a program to redirect the web browser from that web page to a different web page. In this example, the parked domain web page can have a domain name that is a near match or misspelling of another domain name that is not a parked domain and that corresponds to another web page that includes content. The advertisement in this example can redirect (e.g., navigate away from) the user from the parked domain web page to the other web page.

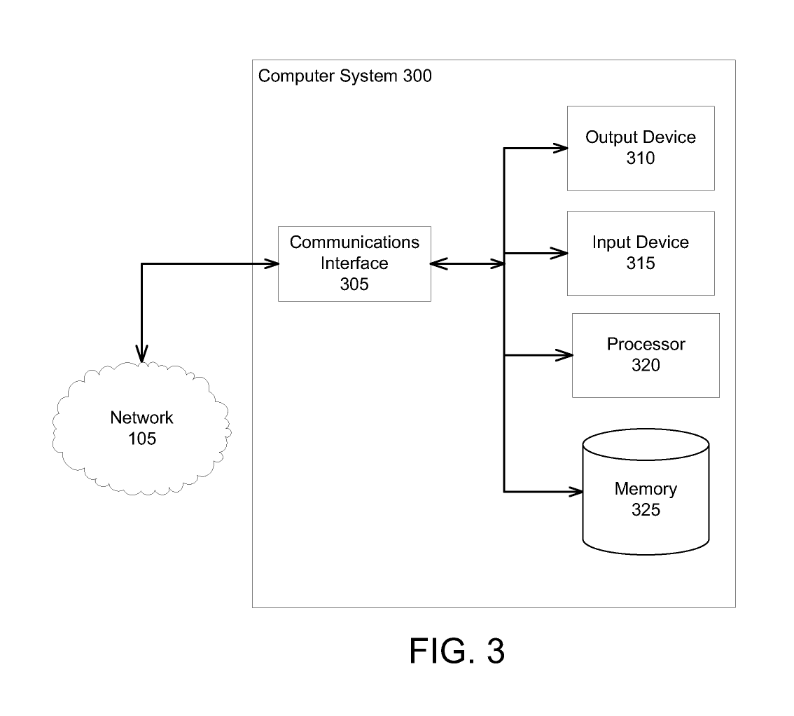

FIG. 3 shows the general architecture of an illustrative computer system 300 that may be employed to implement any of the computer systems discussed herein (including the system 100 and its components such as the data processing system 120, the content placement circuit 130, and the bid evaluation circuit 135) in accordance with some embodiments. The computer system 300 can be used to provide content such as advertisements via the network 305, for example for display as full page advertisements on web pages having parked domains. The computer system 300 of FIG. 3 comprises one or more processors 320 communicatively coupled to memory 325, one or more communications interfaces 305, one or more output devices 310 (e.g., one or more display units) and one or more input devices 315. The processors 320 can be included in the data processing system 120 or the other components of the system 100 such as the content placement circuit 130 or the bid evaluation circuit 135.)

In the computer system 300 of FIG. 3, the memory 325 may comprise any computer-readable storage media, and may store computer instructions such as processor-executable instructions for implementing the various functionalities described herein for respective systems, as well as any data relating thereto, generated thereby, or received via the communications interface(s) or input device(s) (if present). Referring again to the system 100 of FIG. 1, the content placement circuit 130, and the bid evaluation circuit 135 can include or communicate with the memory 325 to store determined or assigned web page values, received bids, determinations of winning bids, or content to be provided for display on web pages. The memory 325 can also include the database 140 of FIG. 1. The processor(s) 320 shown in FIG. 3 may be used to execute instructions stored in the memory 325 and, in so doing, also may read from or write to the memory various information processed and or generated pursuant to execution of the instructions.

The processor 320 of the computer system 300 shown in FIG. 3 also may be communicatively coupled to or control the communications interface(s) 305 to transmit or receive various information pursuant to execution of instructions. For example, the communications interface(s) 305 may be coupled to a wired or wireless network, bus, or other communication means and may therefore allow the computer system 300 to transmit information to and/or receive information from other devices (e.g., other computer systems). While not shown explicitly in the system of FIG. 1, one or more communications interfaces facilitate information flow between the components of the system 100. In some implementations, the communications interface(s) may be configured (e.g., via various hardware components or software components) to provide a website as an access portal to at least some aspects of the computer system 300. Examples of communications interfaces 305 include user interfaces (e.g., web pages) having content (e.g., advertisements) selected by the content placement circuit 130 and provided for placement on the web pages of parked domains.

The output devices 310 of the computer system 300 shown in FIG. 3 may be provided, for example, to allow various information to be viewed or otherwise perceived in connection with execution of the instructions. The input device(s) 315 may be provided, for example, to allow a user to make manual adjustments, make selections, enter data or various other information, or interact in any of a variety of manners with the processor during execution of the instructions. Additional information relating to a general computer system architecture that may be employed for various systems discussed herein is provided at the conclusion of this disclosure.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The content placement circuit 130 and the bid evaluation circuit 135 can include or share one or more data processing apparatuses, computing devices, or processors.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), plasma, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 300 or system 100 can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of the systems and methods described herein. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. For example, the content placement circuit 130 and the bid evaluation circuit 135 can be a single module, a logic device having one or more processing circuits, or part of a search engine.

Having now described some illustrative implementations and embodiments, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one embodiment are not intended to be excluded from a similar role in other implementations or embodiments.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate embodiments consisting of the items listed thereafter exclusively. In one embodiment, the systems and methods described herein consist of one, each combination of more than one, or all of the described elements, acts, or components.

Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements to single or plural configurations. References to any act or element being based on any information, act or element may include embodiments where the act or element is based at least in part on any information, act, or element.

Any implementation disclosed herein may be combined with any other implementation or embodiment, and references to “an implementation,” “some implementation,” “an alternate implementation,” “various implementation,” “one implementation” or the like are not necessarily mutually exclusive and are intended to indicate that a particular feature, structure, or characteristic described in connection with the embodiment may be included in at least one implementation or embodiment. Such terms as used herein are not necessarily all referring to the same embodiment. Any embodiment may be combined with any other embodiment, inclusively or exclusively, in any manner consistent with the aspects and embodiments disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The foregoing embodiments are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A computer implemented method of providing content on a computer network, comprising:
identifying a parked domain of the computer network, wherein the parked domain corresponds to an internet domain name associated with a web page;
assigning, by a data processing system, an assigned value to the web page, the assigned value including an indication of revenue generated by a plurality of content items configured for display on the web page;
receiving, at the data processing system, a bid from a content provider to provide exclusive content for display on the web page;
determining a bid value corresponding to the bid;
comparing the bid value with the assigned value to identify the bid as a winning bid; and
providing the exclusive content corresponding to the winning bid for display on the web page.

2. The method of claim 1, wherein the exclusive content includes a full page content item, further comprising:
exclusively providing the full page content item for display on the web page; and
excluding content other than the full page content item from display on the web page.

3. The method of claim 1, further comprising:
directing a web server of the web page to navigate away from the web page and to a second web page provided by the content provider.

4. The method of claim 1, further comprising:
receiving a request from the content provider to direct traffic from the parked domain to a second web page.

5. The method of claim 1, wherein the exclusive content includes a first full page content item and a second full page content item, the method further comprising:
providing, for display on the web page, the first full page content item during a first time period; and
providing, for display on the web page, the second full page content item during a second time period.

6. The method of claim 1, wherein the exclusive content is customized for display on the web page, based at least in part on the internet domain name associated with the web page.

7. The method of claim 1, further comprising:
receiving, at the data processing system, a second bid to provide content corresponding to the second bid for display on the web page;
determining a bid value corresponding to the second bid;
comparing the bid value corresponding to the second bid with the assigned value to identify the second bid as a losing bid; and
denying the content corresponding to the second bid from display on the web page.

8. The method of claim 1, wherein the exclusive content includes a full page content item, further comprising:
identifying first content displayed on the web page during a first time period;
replacing the first content with the exclusive content; and
providing the exclusive content for display on the web page during a second time period subsequent to the first time period.

9. A system of providing content via a computer network, comprising:
one or more data processors; and one or more storage devices storing instructions that when executed by the one or more data processors, cause the one or more data processors to perform operations comprising:
identifying a parked domain of the computer network, wherein the parked domain corresponds to an internet domain name associated with a web page;
assigning an assigned value to the web page, the assigned value including an indication of revenue generated by a plurality of content items configured for concurrent display on the web page;
receiving, via the computer network, a bid from a content provider to provide exclusive content for display on the web page;
identifying a bid value corresponding to the bid;
comparing the bid value with the assigned value to identify the bid as a winning bid; and
providing the exclusive content corresponding to the winning bid for display on the web page.

10. The system of claim 9 wherein the exclusive content includes a full page content item, further comprising the one or more storage devices storing instructions that when executed by the one or more data processors, cause the one or more data processors to perform operations comprising:
exclusively providing the full page content item for display on the web page; and
excluding content other than the full page content item from display on the web page.

11. The system of claim 9, further comprising the one or more storage devices storing instructions that when executed by the one or more data processors, cause the one or more data processors to perform operations comprising:
directing a web server of the web page to navigate away from the web page and to a second web page provided by the content provider.

12. The system of claim 9, wherein the one or more storage devices storing instructions that when executed by the one or more data processors, cause the one or more data processors to perform operations comprising:
receiving a request from the content provider to direct traffic from the parked domain to a second web page.

13. The system of claim 9, wherein the exclusive content includes a first full page content item and a second full page content item, the one or more storage devices storing instructions that when executed by the one or more data processors, cause the one or more data processors to perform operations comprising:
providing the first full page content item for display on the web page during a first time period; and
providing the second full page content item for display on the web page during a second time period.

14. The system of claim 9, wherein the exclusive content is customized for display on the web page, based at least in part on the internet domain name associated with the web page.

15. The system of claim 9, wherein the one or more storage devices storing instructions that when executed by the one or more data processors, cause the one or more data processors to perform operations comprising:
receiving a second bid to provide content corresponding to the second bid for display on the web page;
determining a bid value corresponding to the second bid;
comparing the bid value corresponding to the second bid with the assigned value to identify the second bid as a losing bid; and
denying the content corresponding to the second bid from display on the web page.

16. The system of claim 9, wherein the exclusive content includes a full page content item, further comprising the one or more storage devices storing instructions that when executed by the one or more data processors, cause the one or more data processors to perform operations comprising:
identifying first content displayed on the web page; and
replacing the first content with the exclusive content.

17. The system of claim 16, wherein the one or more storage devices storing instructions that when executed by the one or more data processors, cause the one or more data processors to perform operations comprising:
providing the exclusive content for display on the web page.

18. A computer readable storage device storing instructions that when executed by one or more data processors, cause the one or more data processors to perform operations comprising:
identifying a parked domain of a computer network, wherein the parked domain corresponds to an internet domain name associated with a web page;
assigning an assigned value to the web page, the assigned value including an indication of revenue generated by a plurality of content items configured for concurrent display on the web page;
receiving a bid to provide exclusive content for display on the web page;
determining a bid value corresponding to the bid;
comparing the bid value with the assigned value to identify the bid as a winning bid; and
providing the exclusive content corresponding to the winning bid for display on the web page.

19. The computer readable storage medium of claim 18, further comprising instructions that when executed by the one or more data processors, cause the one or more data processors to perform operations comprising:
directing a web server of the web page to navigate away from the web page and to a second web page provided by the content provider.

20. The computer readable storage medium of claim 18, wherein the exclusive content includes a full page content item, further comprising instructions that when executed by the one or more data processors, cause the one or more data processors to perform operations comprising:
providing the full page content item for display on the web page.
